(19) United States
(12) Patent Application Publication
(10) Pub. No.: US 2020/0005317 A1
(43) Pub. Date: Jan. 2, 2020

(54) SYSTEM AND METHOD FOR INCREASING SECURITY OF INFORMATION STORAGE AND RETRIEVAL

(71) Applicants: Harel Amor, Tirat Carmel (IL); Kineret Amor Ozeri, Tirat Carmel (IL); Amit Hadad, Hadera (IL)

(72) Inventors: Harel Amor, Tirat Carmel (IL); Kineret Amor Ozeri, Tirat Carmel (IL); Amit Hadad, Hadera (IL)

(21) Appl. No.: 16/451,036

(22) Filed: Jun. 25, 2019

Related U.S. Application Data
(60) Provisional application No. 62/690,968, filed on Jun. 28, 2018.

(51) Int. Cl. G06Q 20/40; G06Q 20/34

(52) U.S. Cl. CPC G06Q 20/4018; G06Q 20/351

(57) ABSTRACT

A computer-implemented method to provide a user with virtual credit card details and increase security of electronic storage and retrieval of a credit card number linked to the virtual credit card is provided herein. The computer-implemented method comprising: receiving: (i) a request to receive virtual credit card number; and (ii) credit card details to link said virtual credit card number; generating virtual credit card details including: (i) the virtual credit card number; (ii) virtual Card Verification Value (CVV); and (iii) an expiration date; receiving from the user CVV related password; calculating a string based on the CVV and the CVV related password and storing it; concatenating the expiration date and the credit card number into a credit card string; dividing the credit card string into portions to be scrambled, encrypted and stored on both user related devices and public servers; and providing the user with the virtual credit card details.

### FIELD OF THE DISCLOSURE

The present disclosure relates generally to the field of electrical digital data processing and cryptographic mechanisms and more specifically, to a system and method for increasing security of information storage and retrieval by splitting the data and saving a portion of the data on a user's personal device and one or more other portions on one or more servers.

### BACKGROUND OF THE DISCLOSURE

Internet usage is in constant growth worldwide. Many internet services are available via the World Wide Web or via mobile applications and allow access to various types of information. For example, via e-commerce, businesses have the option to sell goods and services online and users may consume these goods and services. Another example is governmental offices which provide access for citizen users to their personal information via the governmental official web portal as well as payment of municipal taxes.

In this respect, security issues may arise with regards to leakage and abuse of sensitive information. To minimize these security issues, various cryptography methods known in the art are widely used. One of the well-known cryptography methods uses a pair of public and private key for authentication and verification. In some digital commerce systems, the private key is sent to the end user as part of an executable file such as an audio player and audio file. Thus, attackers can obtain access to the private key. U.S. Pat. No. 7,634,091 discloses a split of the private key up into parts which are obfuscated, but still kept in a form that allows the encrypted data to be decrypted.

U.S. Pat. No. 7,716,484 discloses a method for accessing encrypted data by a client. The method includes receiving from the client by a server client information derived from a first secret wherein the client information is derived such that the server cannot feasibly determine the first secret. The method also includes providing to the client by the server intermediate data, which is derived responsive to the received client information, a server secret, and possibly other information. The intermediate data is derived such that the client cannot feasibly determine the server secret. The method also includes authenticating the client by a device that stores encrypted secrets and is configured not to provide the encrypted secrets without authentication.

US Patent Application Publication 2007/0165865 discloses a method for encrypting data in an arrangement where data is transferred from a sender to a receiver over a communications network, characterized in that the method comprises the steps of splitting the data into at least two parts in a fashion substantially unrelated to the data content, the parts being individually recognizable and connectable with each other by means of key information (208), and sending the parts independently via different identities (212) available in the arrangement, the identities belonging substantially to at least one of the types: server, subscription, address, user identifier.

There is a need for a method and system to provide a virtual credit card and increase security of electronic storage and retrieval of a credit card number linked to the virtual credit card.

Furthermore, there is a need for a method and system to save data that is related to the virtual credit card number and that is not permitted to be retained, such as CVV.

Other aims and advantages of the present disclosure will become apparent after reading the present disclosure and reviewing the accompanying drawings.

### SUMMARY OF THE DISCLOSURE

There is thus provided, in accordance with some embodiments of the present invention a computer-implemented method to provide a user with virtual credit card details and increase security of electronic storage and retrieval of a credit card number linked to the virtual credit card. The computer-implemented method comprising: receiving from a user via a user interface: (i) a request to receive virtual credit card number; and (ii) credit card details to link said virtual credit card number; generating virtual credit card details including: (i) the virtual credit card number; (ii) virtual Card Verification Value (CVV); and (iii) an expiration date; receiving from the user CVV related password;

calculating a string based on the CVV and the CVV related password and storing it; linking the virtual credit card details to the received credit card details; concatenating the expiration date and the credit card number into a credit card string; dividing the credit card string into portions to be scrambled, encrypted and stored on both user related devices and public servers; transmitting one or more portions of the credit card string to be stored on one or more user related devices; transmitting one or more other portions of the credit card number to be stored on one or more public servers; and providing the user via a display unit with the virtual credit card details.

Furthermore, in accordance with some embodiments of the present invention, the method further comprising identifying a payment requirement via an online store and suggesting the user via the user interface to select the virtual credit card to satisfy the payment requirement.

Furthermore, in accordance with some embodiments of the present invention, the method further comprising receiving a selected virtual credit card number from a user via the user interface.

Furthermore, in accordance with some embodiments of the present invention, the method further comprising identifying of payment requirement due to a detected purchase process via an online store and forwarding the selected virtual credit card details to a seller of the online store when the purchase process via the online store has been detected.

Furthermore, in accordance with some embodiments of the present invention, the method further comprising receiving from a finance agent virtual credit card details and accordingly restoring the credit card number from the one or more portions which are stored on the one or more user related devices or on another user related devices and the one or more portions which are stored on the public servers to forward the restored credit card number to the finance agent.

Furthermore, in accordance with some embodiments of the present invention, the identifying of payment requirement is due to a request from the user for the virtual credit card number for a purchase in a phone order or a “mortar and brick” store.

Furthermore, in accordance with some embodiments of the present invention, The method further comprising: detecting a selection from the user of the virtual credit card number via the user interface; requesting from the user via the user interface the CVV related password; receiving from the user via the user interface the password related to the credit card details which are linked to the requested virtual credit card number; and retrieving the CVV based on the provided password to forward to the finance agent.

Furthermore, in accordance with some embodiments of the present invention, the one or more user related devices include at least one of: mobile devices or any other personal devices which are related to the user or another user.

Furthermore, in accordance with some embodiments of the present invention, the received request includes one or more virtual credit cards to be linked to the credit card, and wherein the suggesting includes several options of virtual credit cards.

Furthermore, in accordance with some embodiments of the present invention, the generated virtual credit card number is used to transfer money to a bank account.

Furthermore, in accordance with some embodiments of the present invention, the finance agent is selected from a group consisting of: (i) an acquirer; (ii) a Payment Service Provider (PSP) and (iii) any other organization that is responsible for the exchange of payments.

Furthermore, in accordance with some embodiments of the present invention, the credit card details may include CVV details only.

Furthermore, in accordance with some embodiments of the present invention, a system to provide a user with virtual credit card details and increase security of electronic storage and retrieval of a credit card number linked to the virtual credit card is provided herein. The system comprising: a memory; a display unit; a user interface; and a processor configured to: a receive from a user via a user interface: (i) a request to receive virtual credit card number; and (ii) a credit card number to link said virtual credit card number; b. generate virtual credit card details including: (i) the virtual credit card number; (ii) virtual Card Verification Value (CVV); and (iii) an expiration date; c. receive from a user a CVV related password; d. calculating a string based on the CVV and the CVV related password and storing it; e. linking the virtual credit card details to the received credit card number; f. concatenating the expiration date and the credit card number into a credit card string; g. dividing the credit card string into portions to be scrambled, encrypted and stored on both user related devices and public servers; h. transmitting one or more portions of the credit card string to be stored on one or more user related devices; i. transmitting one or more other portions of the credit card string to be stored on one or more public servers; and j. providing the user via the display unit with the virtual credit card details.

Furthermore, in accordance with some embodiments of the present invention, the processor is further configured to identity a payment requirement and suggesting the user via the user interface to select the virtual credit card to satisfy the payment requirement.

Furthermore, in accordance with some embodiments of the present invention, the processor is further configured to receive a selected virtual credit card number from a user via the user interface.

Furthermore, in accordance with some embodiments of the present invention, the processor is further configured to identify a payment requirement due to a detected purchase process via an online store, and to forward the selected virtual credit card details to a seller of the online store when the purchase process via the online store has been detected.

Furthermore, in accordance with some embodiments of the present invention, the processor is further configured to receive from a finance agent virtual credit card details and accordingly to restore the credit card number from the one or more portions which are stored on the user devices and the one or more portions which are stored on the public servers to forward the restored credit card number to the finance agent.

Furthermore, in accordance with some embodiments of the present invention, the processor is further configured to: (i) detect a selection from the user of the virtual credit card number via the user interface; (ii) request from the user via the user interface the CVV related password; (iii) receive from the user via the user interface the password related to the credit card details which are linked to the requested virtual credit card number; and (iv) retrieve the CVV based on the provided password to forward to the finance agent.

### BRIEF DESCRIPTION OF THE DRAWINGS

In order for the present disclosure, to be better understood and for its practical applications to be appreciated, the following figures are provided and referenced hereafter. It should be noted that the Figures are given as examples only and in no way limit the scope of the disclosure. Like components are denoted by like reference numerals.

FIG. 1 is a block diagram of a system to provide a virtual credit card and increase security of electronic storage and retrieval of a credit card number linked to the virtual credit card, in accordance with some embodiments of the present disclosure;

FIG. 2A is a flowchart depicting current process of an online purchase;

FIG. 2B is a flowchart illustrating a method where the system is connected to a Payment Service Provider (PSP) in the process of an online purchase, in accordance with some embodiments of the present disclosure;

FIG. 3 is a flowchart illustrating a method where the system is connected to an acquirer in the process of an online purchase, in accordance with some embodiments of the present disclosure;

FIG. 4 is a flowchart illustrating a method for storing sensitive data on the system servers and on a user's personal device, in accordance with some embodiments of the present disclosure;

FIG. 5 is a flowchart illustrating an example of the method illustrated in FIG. 4.

FIG. 6 is a flowchart illustrating a method for storage of a type of data that is not permitted to store on business servers and a retrieval of it, in accordance with some embodiments of the present disclosure;

FIG. 7 is a flowchart illustrating a method for generating a new virtual credit card number, in accordance with some embodiments of the present disclosure;

FIG. 8 is a flowchart illustrating a method for purchase and clearing process, in accordance with some embodiments of the present disclosure;

FIG. 9 is a flowchart illustrating a method for calculation of sensitive data from the encrypted portion stored on a personal device and the encrypted portion stored on the server, in accordance with some embodiments of the present disclosure;

FIG. 10 is a flowchart illustrating a method for a stage in a purchase process where the system receives a response from a financial agent (linker), in accordance with some embodiments of the present disclosure;

FIG. 11 is a flowchart illustrating an offline purchase using a credit card;

FIG. 12 is a flowchart illustrating a method for an offline purchase using a virtual credit card number, in accordance with some embodiments of the present disclosure; and

FIG. 13 is a flowchart illustrating a method for a phone purchase, in accordance with some embodiments of the present disclosure; and

FIG. 14 is a flowchart illustrating a method to provide a user with virtual credit card details and increase security of electronic storage and retrieval of a credit card number linked to the virtual credit card, in accordance with some embodiments of the present disclosure.

### DETAILED DESCRIPTION OF THE DISCLOSURE

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

Some embodiments of the disclosure may include an article such as a computer or processor readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein.

As used herein, the term “user's device” refers to at least one of: mobile devices or any other personal devices which are related to the user or another user.

In some embodiments of the disclosure, a system and a method provide storing a portion of the sensitive data on one or more user devices such as a mobile device or any other personal device and one or more portions of the sensitive data on one or more servers, and during any type of process or procedure that was initiated by a user to identify a requirement for the sensitive data and suggest the user to use the sensitive data as an option to continue the process, thus increasing security of information storage and retrieval. The sensitive data may be in a non-limiting example, a social security number or the like, medical information of patients, one or more credit card details and/or one or more virtual credit card details.

According to some embodiments, in case the sensitive data is credit card details i.e. (i) credit card number; (ii) Card Verification Value (CVV); and (iii) expiration date, a system and a method provide generating one or more virtual credit card numbers that will be linked with real credit card details. The system and method may support usage of the one or more virtual credit card numbers for one or more purchases in an online store, via phone order or in “mortar and brick” stores.

According to some embodiments, the generated one or more virtual credit card numbers may be used to transfer money to a bank account.

In some embodiments of the disclosure, the system and method may split the sensitive data and store encrypted portions of the data in dedicated servers and encrypted portions of data on a user's personal device. The personal device may be a mobile phone, a Personal digital assistant (PDA), a tablet, a personal computer, iPad and the like.

In some embodiments of the disclosure, a system and a method may provide restoration of a type of data that is banned i.e., not permitted to be saved, by usage of another data that is known only to the user, such as a password. For example, storage of CVV is prohibited by Payment Card Industry (PCI) security standards, not even in its encrypted format. When part of the sensitive data is a virtual credit cards number, and a CVV is required during purchase, the system and method provide restoration of the CVV number.

In some embodiments of the disclosure, access to the system and method is enabled via any personal device.

In some embodiments of the disclosure, when a user purchases in an online store and paying with the generated virtual credit card details, the system and method is connecting to a finance agent to facilitated exchange of payments. The finance agent may be an acquirer or a Payment Service Provider (PSP) or any other organization that is responsible for the exchange of payments. The financial agent may be referred to as linker.

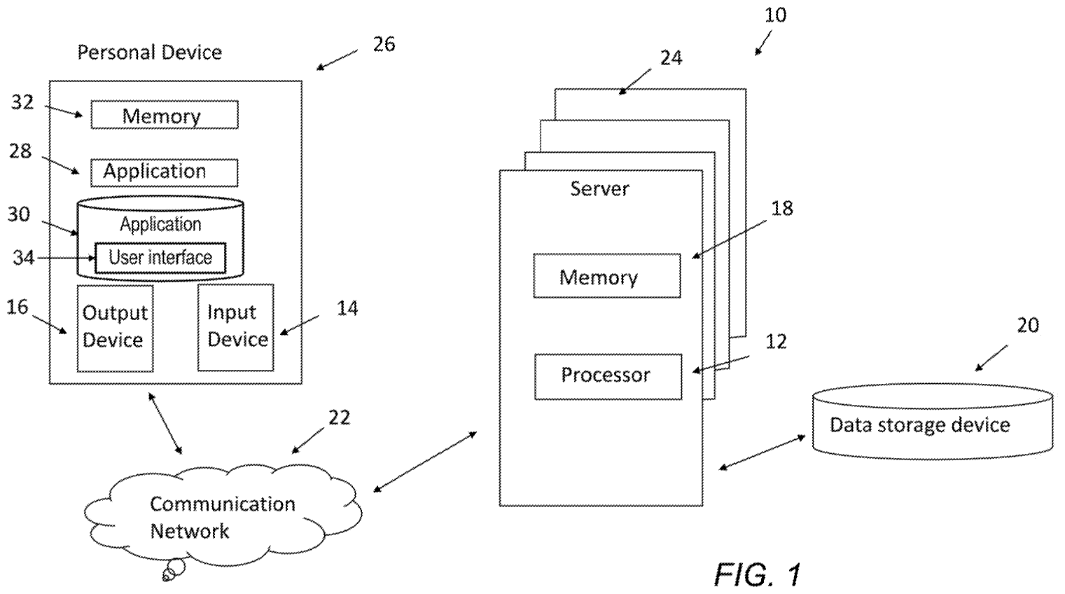

According to some embodiments, a system may be configured to store an encrypted portion of sensitive data on one or more mobile devices or any other personal devices and a portion on one or more servers, and during any type of process or procedure that was initiated by the user to identify a requirement for the sensitive data and suggest the user to use the portion of the sensitive data as an option to continue the process, thus increasing security of information storage and retrieval. Furthermore, the encrypted portion may be scrambled. In the example of FIG. 1, such a system is shown. The server 24 in system 10 includes a processor 12 for generating virtual credit card details and a user's application 28 that is running on the one or more user's personal devices 26.

According to some embodiments, the application 28 on the user's personal device 26 may identify an initiation of an online purchase and in response it may suggest the user (not shown) to use a virtual credit card number. The application 28 may be installed on the user's personal device 26 or connected via the network 22 to the user's personal device 26. In some other embodiments, a website may be configured to replace the functionality of the application 28.

In some embodiments of the disclosure, a user may register to system 10 via the application 28 or via a website (not shown) by entering personal data. The data may be stored in a database in an encrypted format. The login to system 10 may be performed via the application 28 or via a website by the user entering a user name and a password. Alternatively, login to system 10 may be performed via another application such as google Fingerprint or the like.

According to some embodiments of the disclosure, a registered user may request the virtual credit card details via the user interface for purchase via a phone order or a “mortar and brick” store. Upon such a request, the user will be provided with a list of virtual credit card numbers and after selection of one of the virtual credit card numbers, the user will enter via the user interface the virtual CVV related password. The virtual CVV will be retrieved based on the provided password and will be displayed to the user on a display unit.

According to some embodiments of the disclosure, a registered user may input to the system 10 one or more real credit card numbers with its related data and the system 10 will generate one or more virtual credit card details for each real credit card number. The generated virtual credit card numbers are associated with the credit card details. The credit card details include: (i) a credit card number; (ii) Card Verification Value (CVV); and (iii) an expiration date. The generated one or more virtual credit card numbers are saved in the system. In addition to the generated virtual credit card CVV and expiration date will be generated.

According to some embodiments of the disclosure, since CVV is a type of data that is not permitted to be stored according to Payment Card Industry (PCI) Data Security Standard (DSS), the system and method may calculate a new number to be stored in the database. The new number is a calculation of a user's CVV-related password and the CVV. The system doesn't save the user's password.

According to some embodiments of the disclosure, during a purchase when a user chooses to use one of the virtual credit cards which were provided by the system 10, since the CVV is also required, the user will have to input the CVV-related password and the system may calculate the CVV by the number stored in the database and the entered CVV-related password.

According to some embodiments, to prevent hacks or data breaches, a portion of the virtual credit card number may be saved on the user's one or more personal devices 26 and one or more portions on one or more servers 24 of the system 10. The one or more portions may be further encrypted before they are saved on the user's one or more personal devices 26 and one or more portions on one or more servers 24 of the system 10 or the one or more portions may be scrambled and encrypted before they are saved on the user's one or more personal devices 26 and one or more portions on one or more servers 24 of the system 10.

The server 24 represents a combination of one or more servers. For example, processor 12 of server 24 may include one or more processing units, e.g. of one or more computers. Furthermore, processor 12 may be configured to operate in accordance with programmed instructions stored in memory 18.

Furthermore, according to some embodiments, processor 12 may be capable of executing an application for providing virtual credit card details which are linked to credit card details and increasing security of electronic storage and retrieval thereof by storing a portion of sensitive data on a mobile device 26 or any other personal device and one or more portions on one or more data storage devices 20 which are connected to the one or more servers 24.

According to some embodiments, during any type of process or procedure that was initiated by the user, a requirement for the sensitive data is identified by application 28 on the user's personal device 26 and suggest the user via user interface 34 that is connected to the application 28, to use the portion of the sensitive data as an option to continue the process, thus increasing security of information storage and retrieval. The user interface 34 may be displayed to the user via output device 16.

For example, in a purchase process identification of a requirement for credit card details may be identified by application 28.

According to embodiments of the disclosure, the programmed instructions of the application 28 are stored in memory 32. The sensitive data may be the credit card details which include: (i) credit card number; (ii) CVV; and (iii) expiration date. Upon purchase process identification, the user may be prompted to select via the user interface 34 a virtual credit card that the user possesses to complete the transaction. After the user selects a virtual credit card number via the user interface 34 of the application 28 the selected virtual credit card details are forwarded to a seller of the online store.

According to some embodiments, the processor 12 may be further capable of restoring a type of data that is not permitted to be saved in the data storage device 20 or in personal device 26 or anywhere else, by generating and storing different data and retrieving it by using another data that is known only to the user such as a password.

According to some embodiments, processor 12 may communicate, via the communication network 22, with output device 16 that is connected to the application 28 on the user's personal device 26. For example, output device 16 may include a computer monitor or screen. Processor 12 may communicate with a screen of output device 16 via application 28 to display one or more virtual credit cards to the user to use as an option to continue a process. In another example, output device 16 may include a printer, display panel, speaker, or another device capable of producing visible, audible, or tactile output.

According to some embodiments, processor 12 may communicate, via the communication network 22, with input device 14. For example, input device 14 may include one or more of a keyboards, keypad, or pointing device for enabling a user to input data or instructions for operation of processor 12.

According to some embodiments, processor 12 may communicate with memory 18. Memory 18 may include one or more volatile or nonvolatile memory devices. Memory 18 may be utilized to store, for example, programmed instructions for operation of processor 12, data or parameters for use by processor 12 during operation, or results of operation of processor 12

According to some embodiments, processor 12 may communicate with data storage device 20. Data storage device 20 may include one or more fixed or removable nonvolatile data storage devices. For example, data storage device 20 may include a computer readable medium for storing program instructions for operation of processor 12. It is noted that data storage device 20 may be remote from processor 12. Furthermore, data storage device 20 may be utilized to store data or parameters for use by processor 12 during operation, or results of operation of processor 12.

According to some embodiments of the disclosure, the identifying of payment requirement by the application 28 may be due to a request from the user for the virtual credit card number for a purchase in a phone order or a “mortar and brick” store.

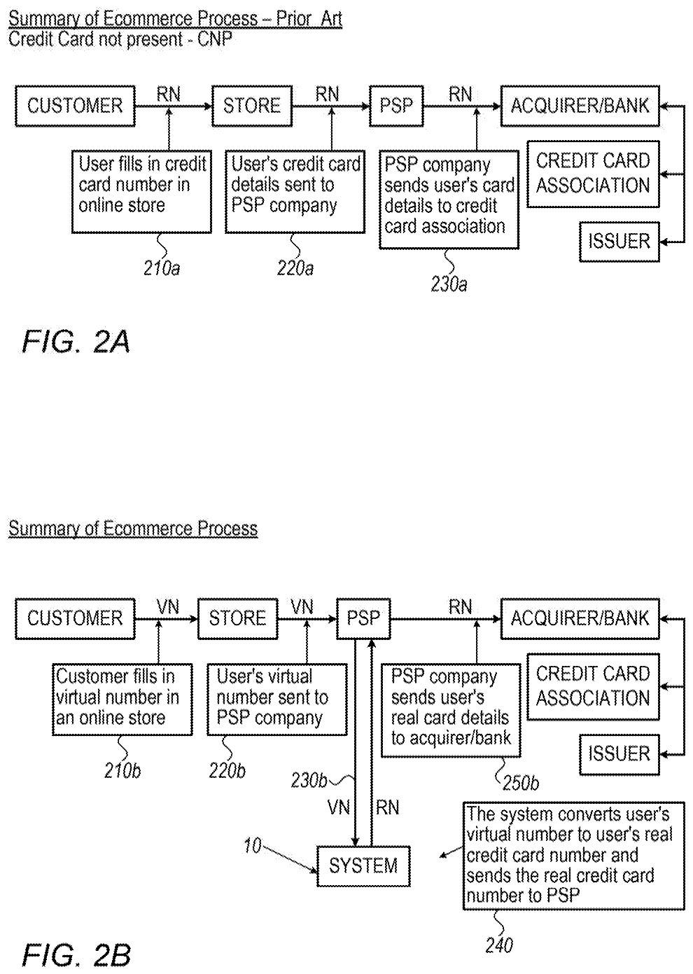

FIG. 2A is a flowchart depicting the current process (i.e., prior art) of online purchase. In an online purchase the credit card is not present. A customer may fill in real number (RN) i.e., credit card details during a purchase in the online store 210a and then the credit card details are sent to a PSP company 220a. The PSP company sends the user's credit card details to a credit card association 230a such as an acquirer or a bank or an issuer.

FIG. 2B is a flowchart illustrating a method where the system is connected to PSP in the process of online purchase, in accordance with some embodiments of the present disclosure. During an online purchase the customer fills in a virtual number (VN) 210b in the online store. The online store sends the user's virtual number details to a PSP company 220b. The PSP company sends to the system 10 the virtual credit card details 230b and in response the system 10 sends to the PSP company the real credit card details 240b, In response, the PSP company sends the user's real credit card details 250b to an acquirer or bank, a credit card association or an issuer.

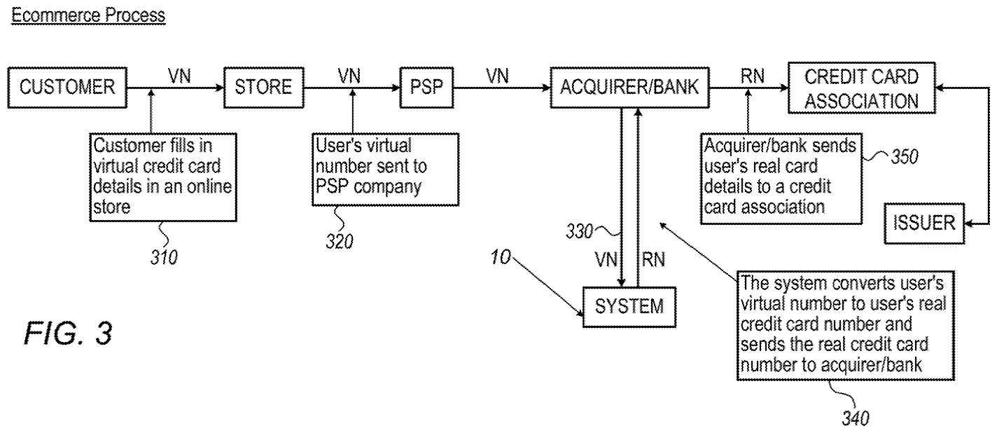

FIG. 3 is a flowchart illustrating a method where the system 10 is connected to an acquirer in the process of online purchase, in accordance with some embodiments of the present disclosure. During an online purchase, after the customer fills in virtual credit card details in the online store 310 the online store sends the virtual credit card details to a PSP company 320. The PSP company sends the virtual credit card details to an acquirer or bank and the acquirer or bank sends to the system 10 the virtual credit card details 330. In response the system 10 converts the user's virtual number to user's real credit card number and sends the real credit card number to an acquirer/bank 340. The acquirer or bank sends the user's real credit card details to a credit card association 350.

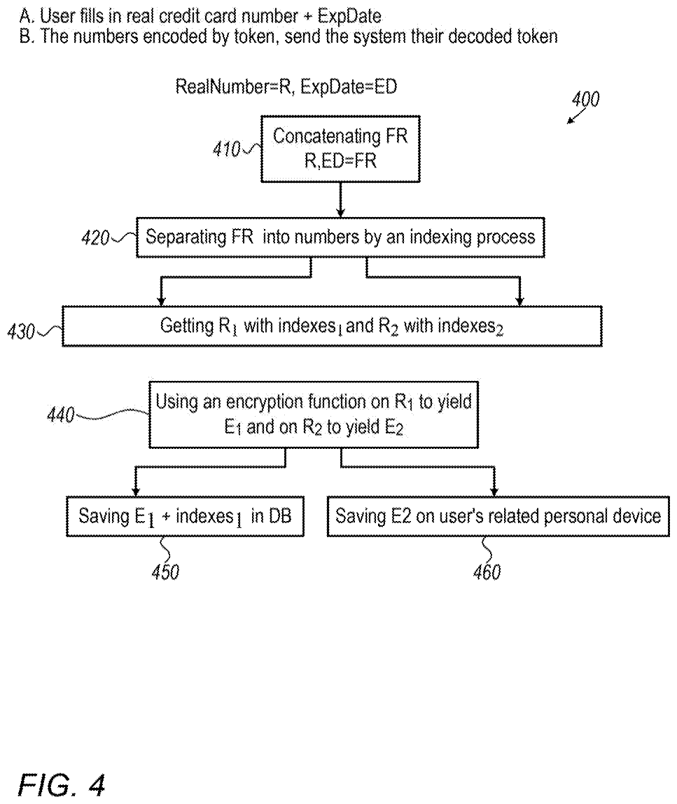

FIG. 4 is illustrating a method for storing sensitive data on the system servers 24 which are connected to data storage device 20 and on the user's personal device 26.

According to some embodiments, the credit card details which include the credit card number and expiration date, that the user has entered may be stored on the data storage device 20 in an encrypted and hashed format. The credit card details may be tokenized, meaning, substituted with non-sensitive equivalent value, that is referred to as a token and transmitted to the server 24. On the server 24, the processor 12 performs detokenization and then operates hash function on the credit card number and the expiration date. The system 10 may randomly divide the credit card number to two or more portions, meaning that each digit of the number can be in each portion randomly. Each portion is encrypted in an encryption function. The encryption function may be for example, Key Management Service (KMS) provided by Amazon web services. Method 400 may be executed by a processor of a computerized system.

According to some embodiments, method 400 may comprise operation 410 which includes concatenating the received real number (R) and the expiration date (ED) into one string (FR).

According to some embodiments, method 400 may comprise operation 420 which includes separating FR into two numbers by an indexing process.

According to some embodiments, method 400 may comprise operation 430 which includes getting R₁ with indexes₁ and getting R₂ with indexes₂.

According to some embodiments, method 400 may comprise operation 440 which includes using encryption function (KMS) on R₁ to yield E₁ and on R₂ to yield E₂.

According to some embodiments, method 400 may comprise operation 450 which includes saving E and indexes₁ saving E₂ on user related personal devices.

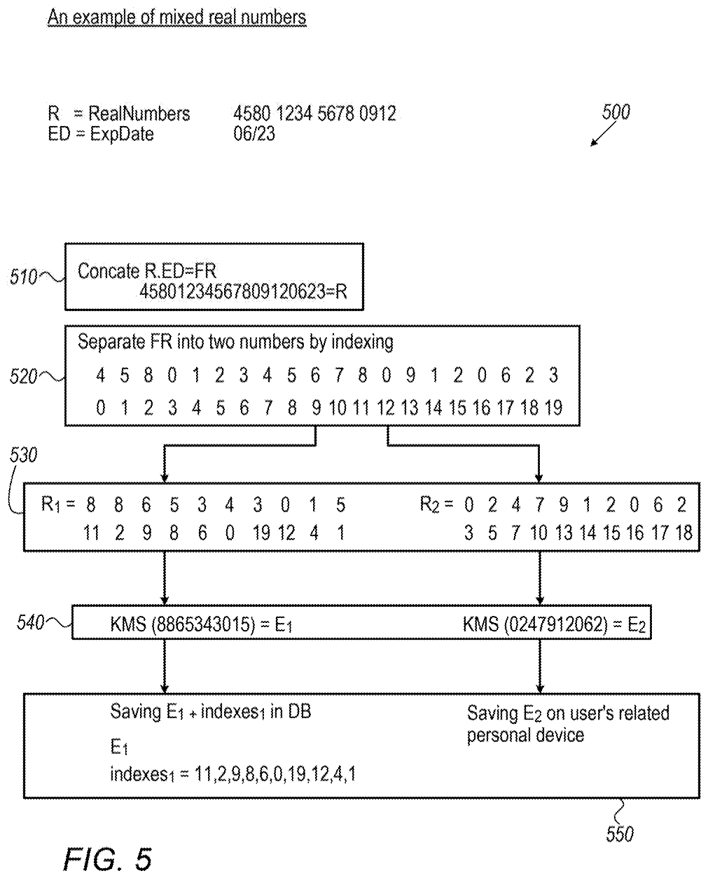

FIG. 5 is illustrating an example of the method illustrated in FIG. 4. In the Example in FIG. 5, R=RealNumbers e.g., 4580 1234 5634 0912 and E=Expiration Date 06/23.

According to the example, operation 510 includes concatenating R and ED to yield FR. E.g., 45801234563409120623. Operation 520 includes separating FR into two portions by an indexing process. For example, the following concatenated string FR:

| | | | | | | | | | | | | | | | | | | | |
|---|---|---|---|---|---|---|---|---|---|---|---|---|---|---|---|---|---|---|---|
| 4 | 5 | 8 | 0 | 1 | 2 | 3 | 4 | 5 | 6 | 7 | 8 | 0 | 9 | 1 | 2 | 0 | 6 | 2 | 3 |
| 0 | 1 | 2 | 3 | 4 | 5 | 6 | 7 | 8 | 9 | 10 | 11 | 12 | 13 | 14 | 15 | 16 | 17 | 18 | 19 |

is divided into two strings by an indexing process:

| | R₁ | | | | | | | | | |
|---|---|---|---|---|---|---|---|---|---|---|
| | 8 | 8 | 6 | 5 | 7 | 8 | 3 | 0 | 1 | 5 |
| Indexes₁ | 11 | 2 | 9 | 8 | 6 | 0 | 19 | 12 | 4 | 1 |
| | R₂ | | | | | | | | | |
| | 0 | 2 | 4 | 7 | 9 | 1 | 2 | 0 | 6 | 2 |
| Indexes₂ | 3 | 5 | 7 | 10 | 13 | 14 | 15 | 16 | 17 | 18 |

In operation 540 the two portions are encrypted by an encryption function into E₁ and E₂. The encryption function may be for example, KMS. Accordingly, KMS(8865343015)=E₁ and KMS(0247912062)=E₂. In operation 550 E₁ and indexes₁ are stored in the database that is connected to the public servers and E₂ is stored on one or more user related personal devices.

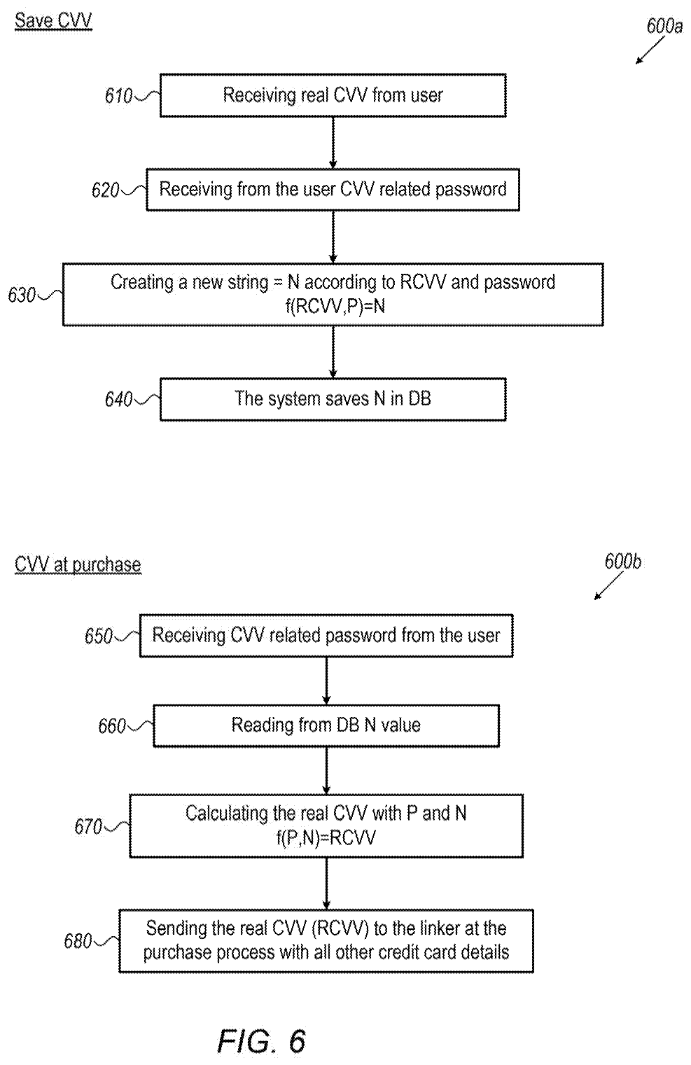

FIG. 6 is illustrating storage of a type of data that is not permitted to store on business servers and retrieval of it, in accordance with some embodiments of the present disclosure.

According to some embodiments, in a non-limiting example, such type of data may be CVV. A user may insert real CVV via input device 14 that is connected to application 28 on the user's personal device 26 and then insert a CVV-related password via input device 14. Accordingly, the system 10 may create a new string N based on a calculation of the real CVV and CVV-related password. The system 10 may associate the string N to a credit card number and save string N in the data storage device 20. During purchase, when the real. CVV is needed, a user may insert CVV-related password via input device 14. On the next step, system 10 may read from data storage device 20 N value. The system 10 may calculate the real CVV given the CVV-related password the user entered and the N value. The system 10 may send the real CVV to a linker at the purchase process with all other real data.

According to some embodiments, method 600a saves the CVV of the credit card in the system. Operation 610 includes receiving real CVV from the user (RCVV). Operation 620 includes receiving CVV related password from the user. Operation 630 includes creating a new string, N according to the RCVV and the received password, f(RCVV,P)=N. In operation 640, saving N in the database 20 that is connected to the servers 24.

According to some embodiments, method 600b retrieves the CVV during the user's purchase. Operation 650 includes receiving CVV related password from the user. In operation 660 reading from the database 20 N value. Operation 670 includes calculating the real CVV with P and N, f(P,N)=RCVV. In operation 680 sending the real CVV (RCVV) to the linker at the purchase process with all other credit card details.

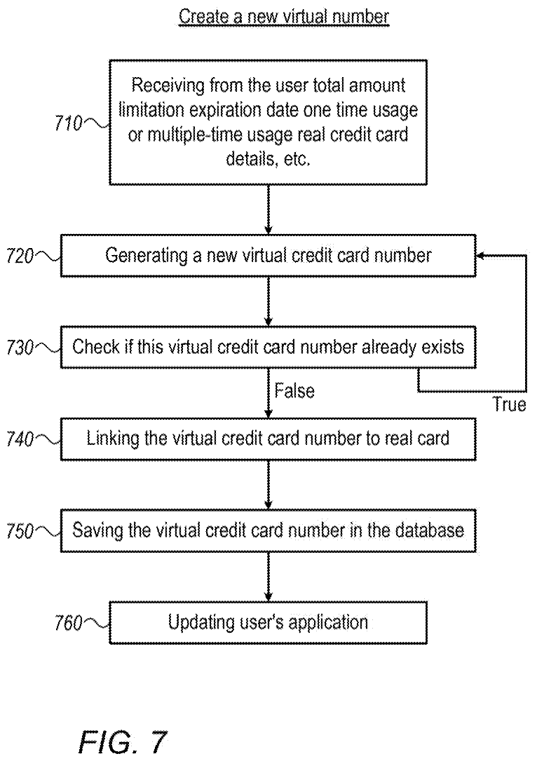

FIG. 7 is illustrating generation of a new virtual credit card number, in accordance with some embodiments of the present disclosure. According to some embodiments, before a virtual credit card number is generated, in operation 710, the system 10 is receiving from a user the following parameters: total amount limitation; expiration date; one-time or multiple-time usage; specific days limitation; specific hours limitation; specific dates limitation; credit card details that will be linked to the generated virtual credit card; specific payment-receiver limitation and the like. Operation 720 includes generating a new virtual credit card number.

According to some embodiments, next in operation 730, the system 10 is checking if the new virtual credit card number already exists in the data storage device 20 meaning, if the virtual number is in use or was in use in a predefined period of time. In case, the credit card number exists, or the virtual credit card number was in use in a predetermined period of time, the system 10 is repeating operation 720 and generating a new number and later operation 730 until the result is that the virtual credit card number does not exist in system 10. If the virtual credit card number does not exist in system 10, operation 740 includes linking the virtual credit card number to the real credit card details and next operation 750 includes saving the virtual credit card number in the database, i.e., data storage device 20 that is connected to the servers 24. Operation 760 includes updating the user's application 28 and store it in the data storage device 20 that is connected to the one or more servers 24.

According to some embodiments, all the above-mentioned parameters may be changed by the user via the input device 14 that is connected to the application 28 or via the user interface 34. The user interface 34 may provide the option to cancel the virtual credit card number at any given moment.

According to some embodiments, the virtual credit card number may be used for standing order.

According to some embodiments, the virtual credit card may be used in the internet anonymously.

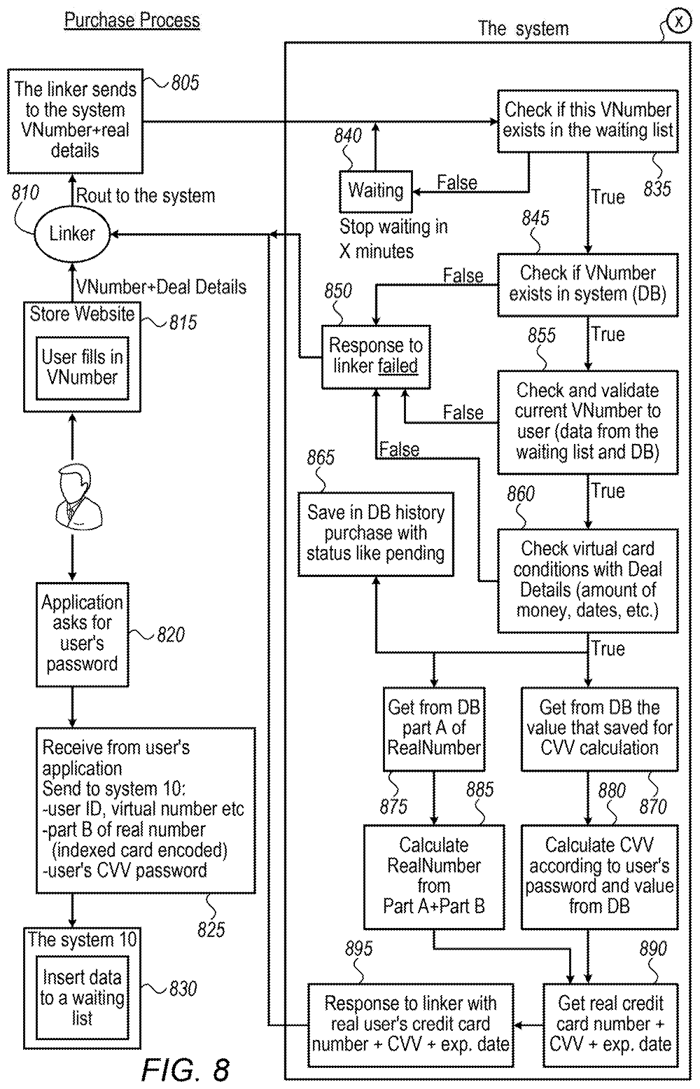

FIG. 8 illustrates the steps of a purchase and a clearing process.

According to some other embodiments of the disclosure, when a user purchases via a store website, the user may fill in via an input device 14 that is connected to the application 28, a virtual credit card number, and the CVV-related password. The application 28 may forward the virtual credit card number to the store website. Next, the store website sends the virtual number and the deal details to a linker to complete the transaction. Then, the linker identifies the virtual number and routs the virtual number and the deal details to the system 10.

A user may contact a store website and fill in the virtual credit card number 815. The virtual credit card number and deal details may be transferred to a linker 810. The linker may send to the system 10 the virtual credit card number and real details 805. In operation with step 820, the application asks for user's password. Upon reception of the password in operation with step 825, the application sends to system 10 the following: user ID, virtual number etc. part B of real number (indexed card encoded) and user's CVV password. In operation with step 830, the system 10 inserts the data received from the application 28 to a waiting list.

The system 10 may receive a request from a financial agent (i.e. linker), including the virtual credit card details and the purchase details, for credit card details which are associated with the chosen virtual credit card details.

According to some embodiments of the disclosure, the system 10 may verify the virtual credit card number received from the financial agent and the virtual credit card number received from the application 28 on the user's personal device 26. The system 10 may also validate and check the virtual credit card number with the user id. On the next step, checking the virtual credit card conditions. In case the check is successful, then the virtual credit card conditions and predetermined parameters are checked. In case the check failed, sending a message to the financial agent with the relevant error message and accordingly updating the application 28.

According to some embodiments of the disclosure, in operation with step 835, system 10 may check if the virtual credit card number that has been received from the linker 810 exists in the waiting list. In case virtual credit card number does not exist, the system is waiting 840 and stops waiting after predetermined amount of time (x). In other words, system 10 may verify the virtual credit card number that has been received from the financial agent and the virtual credit card number received from the application 28 on the user's related personal device 26. In operation with step 845, the system 10 may check if the virtual credit card number exist in the data storage device i.e., database 20 of the system 10. In operation with step 850, if virtual credit card number does not exist, the system 10 may send a ‘failure response’ to the linker 810 and update the user's application accordingly.

According to some embodiments, in operation with step 855, system 10 may check and validate current virtual credit card number to user (data from the waiting list and database). In other words, the system 10 may also validate and check the virtual credit card number with the user id. In case the number does not exist, the system 10 may send a failure response to the linker 850 and update the application accordingly.

According to some embodiments, system. 10 may check the conditions of the virtual credit card towards the deal details. For example, amount of money, dates etc. If the check is successful, then the system 10 may perform the following actions: (i) save history of purchase in data storage device 20; (ii) get from the data storage device 20 the part of the real number; and (iii) get from the data storage device 20 the calculated value that was saved for CVV. These actions are further detailed below. Hence, in operation with step 860, the system 10 may check the virtual credit card conditions with deal details (amount of money, dates, etc.) and predetermined parameters.

According to some embodiments, further in operation with step 850, in case the conditions and predetermined parameters of the virtual credit card do not meet the terms of the purchase, meaning the check resulted in failure, the system 10 may send a failure message to the financial agent (i.e. linker) with the relevant error, and update user's application too. In case the conditions and predetermined parameters of the virtual credit card meet the terms of the purchase, the system 10 may calculate and send the real credit card number and CVV to the linker according to the following steps.

According to some embodiments of the disclosure, in case the verification process succeeded the system may check if the virtual credit card number hasn't been expired. Furthermore, the system may check the remaining balance including other transactions performed on the same time, to ensure the amount is sufficient for the current transaction.

According to some embodiments of the disclosure, the system may check other conditions or predetermined parameters which are associated with the virtual credit card number such as: one-time or multiple-time usage; date limitation; specific day limitation; hours limitation; payment receiver limitation and any other limitation related to the virtual credit card number. The steps of purchase and clearing process by using the virtual credit card number as illustrated in FIG. 8.

According to some embodiments, in case the conditions that were checked in step 860 were confirmed, in operation with step 870, the system may get from the database 20 the value saved for CVV calculation.

According to some embodiments of the disclosure, in case all limitations are valid and in operation with step 875, the system 10 may get from database 20 part A of the real credit card number and in operation with step 885 the system 10 may calculate the real credit card number from part A and Part B.

According to some embodiments of the disclosure, in case all limitations are valid and in operation with step 880, the system 10 may calculate the real CVV number according to the user's entered password (i.e. CVV-related password) and the retrieved number which is the value in the data storage that represented the CVV. System 10 may get from the data storage device 20 the value that represented the CVV i.e. the number that was calculated from the user's CVV-related password and the CVV.

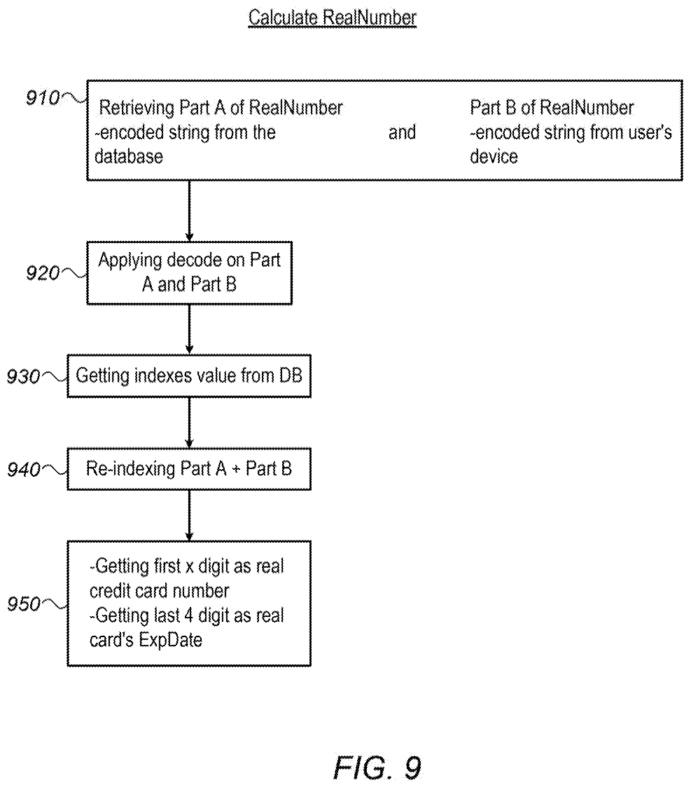

In operation with step 890, the system 10 may get the real credit card number, the CVV and the expiration date. The encrypted portion of the credit card number that is stored on the user's personal device 26 including other details, such as virtual credit card number, CVV-related password, user id and the like, may be sent via the application 28 on the user's personal device 26 to the server 24 of the system 10. System 10 may calculate the real credit card number as further described in FIG. 9.

According to some embodiments of the disclosure, in operation with step 895, the system 10 may send the real credit card number and the real CVV to the financial agent (i.e. linker) so the purchase process may continue.

According to some embodiments of the disclosure, in case the limitations are not valid for the current purchase the system 10 may send a refusal notice to the financial agent (i.e., linker) as shown in step 850 and update the application 28 accordingly.

FIG. 9 is a flowchart illustrating calculation of the sensitive data from the encrypted portion stored on the personal device and the encrypted portion stored on the server, in accordance with some embodiments of the present disclosure.

According to some embodiments of the disclosure, in case all limitations are valid system 10 may calculate the real credit card number and expiration date that the virtual credit card is associated with. Operation 910 includes getting from the database i.e., data storage device 20, the saved part of the credit card number, i.e., an encoded string. Operation 920 includes getting the saved part i.e., encoded string, which was saved in storage 30, from the user's application 28.

According to some embodiments of the disclosure, in operation 920 the system 10 may calculate the real credit card number by implementing a decoding function on the saved part that was retrieved from the data storage device 20 and also on the part of the number that was received from the user's application. The decoding function may be for example, a reverse KMS function provided by Amazon web services. In operation 930, the system is getting indexes from the data storage device 20 and then in operation 940 the system 10 is re-indexing the saved parts in the original order according to the indexes. In operation 950 the system 10 is getting first X digits as real credit card number and then get the last Y digits as real credit card number expiration date.

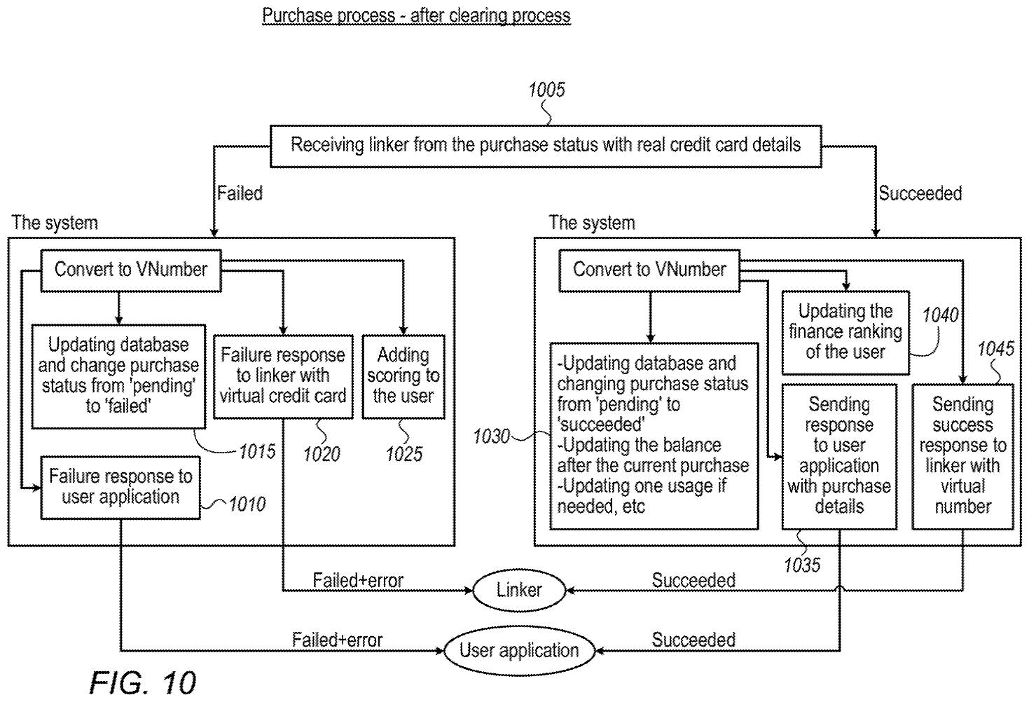

FIG. 10 is a flowchart illustrating a method for a stage in a purchase process where the system 10 receives a response from the financial agent, in accordance with some embodiments of the present disclosure. After the clearing process has been finished, operation 1010 includes receiving from the financial agent (i.e. linker) the status of the purchase which has been performed with real credit card details. In case the purchase process has been failed, the system 10 may perform the following: (i) sending a failure response to the user's application; (ii) on operation 1015 updating the database i.e., data storage 20 device and updating purchase status from ‘pending’ to ‘failed’. (iii) operation 1020 includes sending failure response to the financial agent (i.e. linker) with the virtual credit card number in case the linker didn't save the match of the virtual credit card to this user; (iv) in operation 1025 adding or updating finance ranking of the user.

In case the purchase process has been successful, the system 10 may perform the following steps: (i) operation 1030 includes updating the database i.e., data storage device 20 and updating the purchase status from ‘pending’ to succeeded’, and updating the balance after the current purchase and updating one usage if needed, etc.; if the virtual credit card has been configured by the user for a single usage then inactivate the virtual credit card after one purchase; (ii) operation 1035 includes sending response to user application 28 with details of this purchase; (iii) operation 1040 includes updating the finance ranking of the user; (iv) operation 1045 includes sending a success response to financial agent (i.e. linker) along with the virtual credit card number in case the linker didn't save the match of the virtual card to this user.

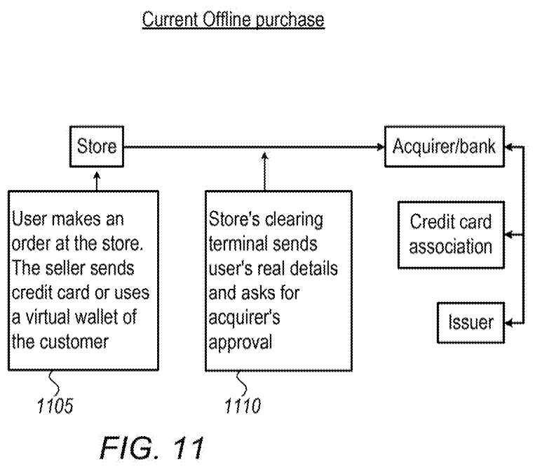

FIG. 11 is a flowchart illustrating an offline purchase using a real credit card, Currently, when a user makes an order at a store, the customer provides a real credit card or uses a virtual wallet 1105. The store is commonly connected to a clearing terminal which processes the user's real details and ask for acquiring approval 1110, where, the clearing terminal may be connected to an acquirer bank; a credit card association or an issuer.

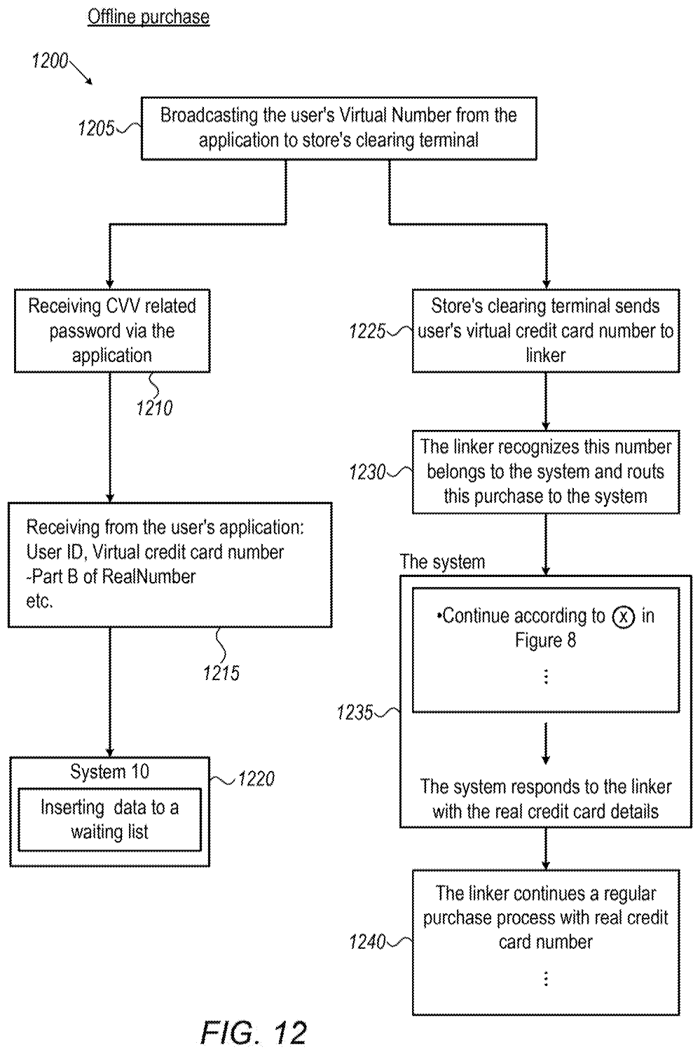

FIG. 12 is a flowchart illustrating a method for an offline purchase using a virtual credit card number provided by the system 10, in accordance with some embodiments of the present disclosure. According to some embodiments of the disclosure, when a user wishes to perform an offline purchase with a virtual credit card provided by the system 10, operation 1205 includes broadcasting the virtual credit card number of the user from the user's application 28 to the store's clearing terminal by NFC/QR code or any other technique. In response, operation 1210 includes receiving from the user via application 28 user's CVV related password. Operation 1215 includes receiving from the user's application, the following parameters: the user id, virtual credit card number etc., saved part of the real credit card number and the user's virtual credit card number and all other data. Operation 1220 includes the system 10 inserting data into a waiting list, waiting for the data from the user to match the user to the purchase.

According to some embodiments of the disclosure, in parallel to the process performed by the application 28 on the user's personal device 26, the store's clearing terminal may send user's virtual credit card number to the financial agent (i.e. linker) 1225. The linker may recognize that the virtual credit card number belongs to the system 10 and rout this purchase to the system 10 1230. Then the system. 10 may continue the purchase process as illustrated in FIG. 8, and response to the linker with the real credit card details 1235. On the next step, the linker may continue a regular purchase process with a real credit card number 1240.

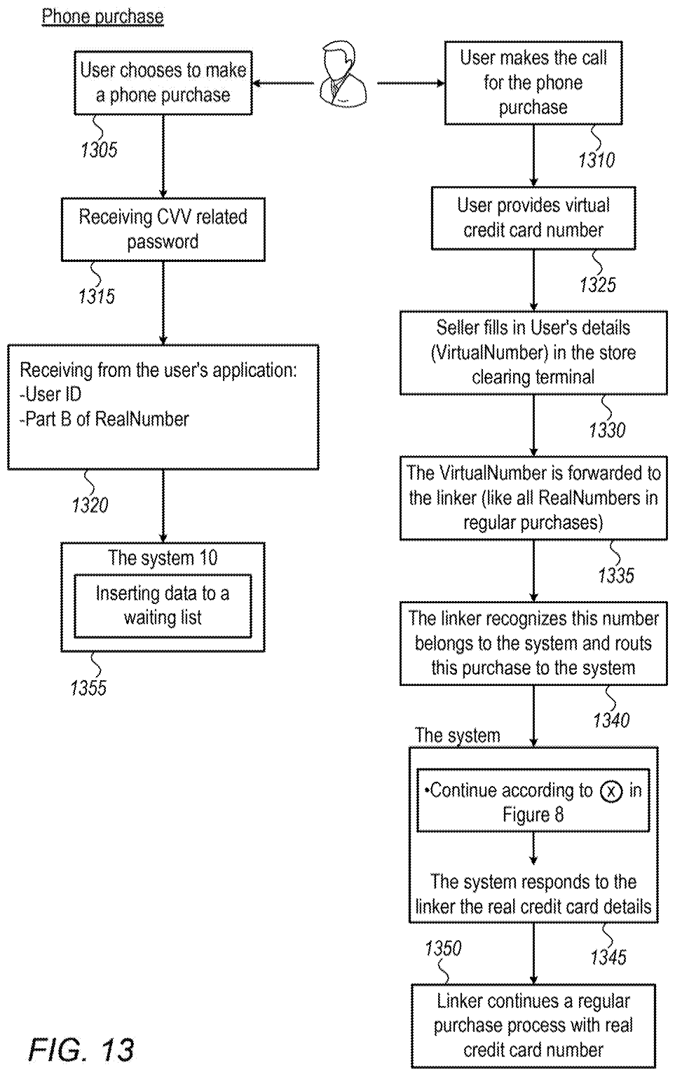

FIG. 13 is a flowchart illustrating a method for a phone purchase, in accordance with some embodiments of the present disclosure. According to some embodiments of the disclosure, when a user would like to perform a phone purchase, the user may choose that option via the output device 16 connected to the application 28 on the user's personal device 26 1305 and make a call for the phone purchase 1310. On the next step, receiving via the application 28 from the user the CVV-related password 1315. On the next step, the user's application 28 may send to the system 10, via communication network 22, the following parameters: user id, saved part of the real credit card number and any other relevant data 1320. Accordingly in operation with step 1355, the system may insert the data into a waiting list.

During the phone call, the user may provide the virtual credit card number for the seller to fill in the user's details 1325. The seller may fill this data into the seller's system and later the data is sent to a linker (could be any linker in the process) 1330. When the virtual credit card number is forwarded to the linker 1335 from the seller, the linker recognizes the credit card number and sends to the system 10 the purchase details 1340. In operation with step 1345, the system 10 may continue the purchase process as illustrated in FIG. 8. On the next step the system 10 may send to the linker the real credit card details so the linker may continue the purchase process 1350.

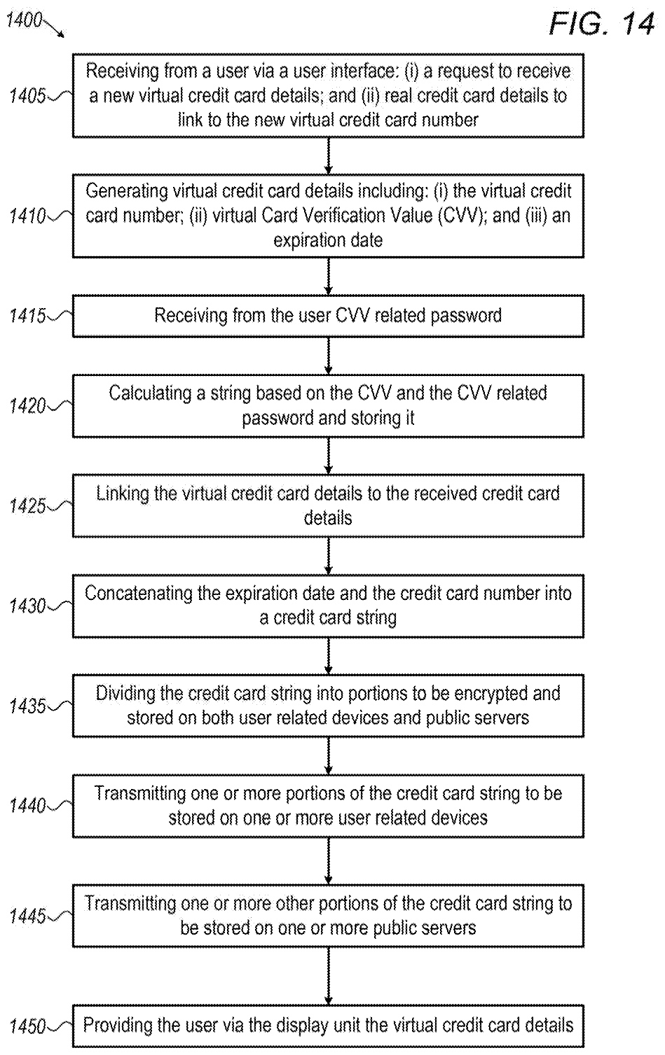

FIG. 14 is a flowchart illustrating a method 1400 to provide a user with virtual credit card details and increase security of electronic storage and retrieval of a credit card number linked to the virtual credit card, in accordance with some embodiments of the present disclosure.

According to some embodiments of the disclosure, operation 1405 includes

receiving from a user via a user interface: (i) a request to receive a new virtual credit card details; and (ii) real credit card details to link to the new virtual credit card number, operation 1410 includes
generating virtual credit card details including: (i) the virtual credit card number; (ii) virtual Card Verification Value (CVV); and (iii) an expiration date operation 1415 includes receiving from the user CVV related password, operation 1420 includes calculating a string based on the CVV and the CVV related password and storing it.

According to some embodiments of the disclosure, operation 1425 includes linking the virtual credit card details to the received credit card details. Operation 1430 includes concatenating the expiration date and the credit card number into a credit card string. Operation 1435 includes dividing the credit card string into portions to be encrypted and stored on both user related devices and public servers. Operation 1440 includes transmitting one or more portions of the credit card string to be stored on one or more user related devices. Operation 1445 includes transmitting one or more other portions of the credit card string to be stored on one or more public servers; and operation 1450 includes providing the user via the display unit the virtual credit card details.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments: thus certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computer-implemented method to provide a user with virtual credit card details and increase security of electronic storage and retrieval of a credit card number linked to the virtual credit card, the computer-implemented method comprising:
receiving from a user via a user interface: (i) a request to receive virtual credit card details; and (ii) credit card details to link said virtual credit card number;
generating virtual credit card details including: (i) the virtual credit card number; (ii) virtual Card Verification Value (CVV); and (iii) an expiration date;
receiving from the user CVV related password;
calculating a string based on the CVV and the CVV related password and storing it;
linking the virtual credit card details to the received credit card details;
concatenating the expiration date and the credit card number into a credit card string;
dividing the credit card string into portions to be encrypted and stored on both user related devices and public servers;
transmitting one or more portions of the credit card string to be stored on one or more user related devices;
transmitting one or more other portions of the credit card number to be stored on one or more public servers; and
providing the user via a display unit with the virtual credit card details.

2. The computer-implemented method according to claim 1, the method further comprising identifying a payment requirement via an online store and suggesting the user via the user interface to select the virtual credit card to satisfy the payment requirement.

3. The computer-implemented method according to claim 2, the method further comprising receiving a selected virtual credit card number from a user via the user interface.

4. The computer-implemented method according to claim 3, the method further comprising identifying of payment requirement due to a detected purchase process via an online store, and forwarding the selected virtual credit card details to a seller of the online store when the purchase process via the online store has been detected.

5. The computer-implemented method according to claim 4, the method further comprising receiving from a finance agent virtual credit card details and accordingly restoring the credit card number the credit card number from the one or more portions which are stored on the one or more user related devices or on another user related devices and the one or more portions which are stored on the public servers to for ward the restored credit card number to the finance agent.

6. The computer-implemented method according, to claim 2, wherein the identifying of payment requirement is due to a request from the user for the virtual credit card number for a purchase in a phone order or a “mortar and brick” store.

7. The computer-implemented method according to claim 2, the method comprising:
detecting a selection from the user of the virtual credit card number via the user interface;
requesting from the user via the user interface the CVV related password;
receiving from the user via the user interface the password related to the credit card details which are linked to the requested virtual credit card number; and
retrieving the CVV based on the provided password to forward to the finance agent.

8. The computer-implemented method according to claim 1, wherein the one or more user related devices include at least one of mobile devices or any other personal devices which are related to the user or another user.

9. The computer-implemented method according to claim 2, wherein the received request includes one or more virtual credit cards to be linked to the credit card, and wherein the suggesting includes several options of virtual credit cards.

10. The computer-implemented method according to claim 1, the generated virtual credit card number is used to transfer money to a bank account.

11. The computer-implemented method according to claim 5, wherein the finance agent is selected from a group consisting of: (i) an acquirer; (ii) a Payment Service Provider (PSP) and (iii) any other organization that is responsible for the exchange of payments.

12. The computer-implemented method according to claim 1, wherein the credit card details include CVV details only.

13. A system to provide a user with virtual credit card details and increase security of electronic storage and retrieval of a credit card number linked to the virtual credit card, the system comprising:
a memory;
a display unit;
a user interface;
and
a processor configured to:
a. receive from a user via a user interface: (i) a request to receive virtual credit card number; and (ii) a credit card number to link said virtual credit card number;
b. generate virtual credit card details including: (i) the virtual credit card number; (ii) virtual Card Verification Value (CVV); and (iii) an expiration date;
c. receive from a user a CVV related password;
d. calculating a string based on the CVV and the CVV related password and storing it;
e. linking the virtual credit card details to the received credit card number;
f. concatenating the expiration date and the credit card number into a credit card string;
g. dividing the credit card string into portions to be encrypted and stored on both user related devices and public servers;
h. transmitting one or more portions of the credit card string to be stored on one or more user related devices;
i. transmitting one or more other portions of the credit card string to be stored on one or more public servers; and
j. providing the user via the display unit with the virtual credit card details.

14. The system of claim 12, wherein the processor is further configured to identify a payment requirement and suggesting the user via the user interface to select the virtual credit card to satisfy the payment requirement.

15. The system of claim 13, wherein the processor is further configured to receive a selected virtual credit card number from a user via the user interface.

16. The system of claim 14, wherein the processor is further configured to identify a payment requirement due to a detected purchase process via an online store, and to forward the selected virtual credit card details to a seller of the online store when the purchase process via the online store has been detected.

17. The system of claim 15, wherein the processor is further configured to receive from a finance agent virtual credit card details and accordingly to restore the credit card number from the one or more portions which are stored on the user devices and the one or more portions which are stored on the public servers to forward the restored credit card number to the finance agent.

18. The system of claim 13, wherein the identifying of payment requirement is due to a request from the user for the virtual credit card number for a purchase in a phone order or a “mortar and brick” store.

19. The system of claim 13, wherein the processor is further configured to: (i) detect a selection from the user of the virtual credit card number via the user interface; (ii) request from the user via the user interface the CVV related password; (iii) receive from the user via the user interface the password related to the credit card details which are linked to the requested virtual credit card number; and (iv) retrieve the CVV based on the provided password to forward to the finance agent.

20. The system of claim 12, wherein the one or more user devices include at least one of mobile devices or any other personal devices which are related to the user or another user.

21. The system of claim 13, wherein the received request includes one or more virtual credit cards to be linked to the credit card, and wherein the suggesting includes several options of virtual credit cards.

22. The system of claim 13, the generated virtual credit card number is used to transfer money to a bank account.

23. The system of claim 16, wherein the finance agent is selected from a group consisting of: (i) an acquirer; (ii) a Payment Service Provider (PSP) and (iii) any other organization that is responsible for the exchange of payments.
